(19) United States
(12) Patent Application Publication
(10) Pub. No.: US 2021/0049206 A1
(43) Pub. Date: Feb. 18, 2021

(54) COMPUTER IMPLEMENTED METHOD AND A COMPUTER SYSTEM FOR DOCUMENT CLUSTERING AND TEXT MINING

(71) Applicants: E. Laxmi Lydia, Andhra Pradesh (IN); A. Krishna Mohan, Andhra Pradesh (IN); K. Vijaya Kumar, Andhra Pradesh (IN)

(72) Inventors: E. Laxmi Lydia, Andhra Pradesh (IN); A. Krishna Mohan, Andhra Pradesh (IN); K. Vijaya Kumar, Andhra Pradesh (IN)

(21) Appl. No.: 16/658,060

(22) Filed: Oct. 19, 2019

(30) Foreign Application Priority Data
Aug. 16, 2019 (IN) 201941033181

(51) Int. Cl. G06F 16/906; G06K 9/62; G06F 16/901; G06F 16/93

(52) U.S. Cl. CPC G06F 16/906; G06F 16/93; G06F 16/901; G06K 9/6223

(57) ABSTRACT

A computer implemented method for document clustering comprises receiving one or more documents via one or more input means, arranging the one or more documents into a term-document matrix using term frequency-inverse document frequency, removing and stemming of one or more common clutter/stop words from the one or more documents, extracting one or more features from the one or more documents using non-negative matrix factorization (NMF) and k means, determining one or more vectors based on the one or more features, implementing k-means clustering thereby iterating the one or more documents and the one or more features and clustering the one or more documents based on similarity between the extracted one or more features and the each of the one or more documents.

### TECHNICAL FIELD

Embodiments of the present invention generally relate to Big Data and Data mining and more particularly to a computer-implemented method and a computer system for document clustering and text mining.

### BACKGROUND

The essential structure for organization of computer files are setting them into folders and putting the folders again into some more elevated level folders. To put these files into folders physically, data about the content of the files are required. Normally the name of document is sufficient to give impression of the contents of the files as needs be to which the files can be grouped together. There are certain instances in which it gets to be hard to physically group the files, for example when they are in huge number, when their contents can't be recognized from their names. This is where there is a passionate need of computer aided clustering of the documents.

Recently there has been surge of interest in document clustering after update rules for NMF proved to perform better than Latent Semantic Indexing (LSI) with Singular Value Decomposition (SVD). Many researchers are approaching with efficient algorithms and comprehensive comparison of the existing algorithms but, still, these have been limited to academics.

Few attempts have been made to achieve the objective such as Satish Muppidi et al (2015): has explained in their work documents clustering using Hadoop framework. In this work stop word elimination and stemming methods are used to pre-process the input documents and find keywords of every document and make them into vector space model for document clustering. They used iterative algorithm to calculate tfidf weight on MapReduce in order to evaluate important a term is to a document in a corpus. In the process of document clustering used K-means algorithm procedure with distributed environment. They used a MapReduce algorithm for efficiently computing pair wise document similarity in large document collections. The map and reduce functions run on distributed nodes in parallel. Each map operation can be processed independently on each node and all the operations can be performed in parallel.

Further, Xu, W, Liu, X & Gong, Y (2003): There is an analogy with the SVD in interpreting the meaning of the two nonnegative matrices U and V. Each element uij of matrix U represents the degree to which term fi ∈ W belongs to cluster j, while each element vij of matrix V indicates to which degree document i is associated with cluster j. If document i solely belongs to cluster x, then vix will take on a large value while rest of the elements in i^{th} row vector of V will take on a small value close to zero. II[9] From the work of Kanjani K [12] it is seen that the accuracy of algorithm from Lee and Seung [3] is higher than their derivatives [9,10]. In this work, the original multiplicative update proposed by Lee and Seung in [3] is undertaken.

But the existing solutions failed to provide a method or a system to overcome the problem of grouping and clustering the documents. Therefore, in light of the foregoing discussion, there exists a need to overcome the aforementioned drawbacks associated with the prior art for a computer implemented method and a computer system for document clustering and text mining.

### SUMMARY OF THE INVENTION

According to a first aspect of the present invention, there is provided a computer-implemented method for document clustering. The method comprises receiving one or more documents via one or more user interface module, arranging the one or more documents into a term-document matrix using term frequency-inverse document frequency, removing and stemming of one or more common clutter/stop words from the one or more documents, extracting one or more features from the one or more documents using non-negative matrix factorization (NMF) and k means, determining one or more vectors based on the one or more features, implementing k-means clustering thereby iterating the one or more documents and the one or more features and clustering the one or more documents based on similarity between the extracted one or more features and the each of the one or more documents.

In accordance with an embodiment of the present invention, the method further includes forming an index of the one or more documents using an index server.

In accordance with an embodiment of the present invention, the one or more documents are large in size, implementing MapReduce to cluster the one or more documents thereby reducing computational time.

In accordance with an embodiment of the present invention, the one or more documents are new, defining and updating the one or more documents in the index.

According to a second aspect of the present invention, there is provided a computer system for document clustering comprises a memory unit configured to store machine-readable instructions and a processor operably connected with the memory unit, the processor obtaining the machine-readable instructions from the memory unit, and being configured by the machine-readable instructions to receive one or more documents via one or more user interface module, arrange one or more documents into a term-document matrix using term frequency-inverse document frequency, remove and stem one or more common clutter/stop words from the one or more documents, extract one or more features from the one or more documents using non-negative matrix factorization (NMF) and k means, determine one or more vectors depending on the one or more features, implement k-means clustering thereby iterating the one or more documents and the one or more features and cluster the one or more documents based on similarity between the extracted one or more features and the each of the one or more documents.

In accordance with an embodiment of the present invention, the system further includes an index server configured to form an index of the one or more documents.

In accordance with an embodiment of the present invention, the one or more documents are large in size, implementing MapReduce to cluster the one or more documents thereby reducing computational time.

In accordance with an embodiment of the present invention, the one or more documents are new, define and update the one or more documents in the index.

### BRIEF DESCRIPTION OF THE DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein

FIG. 1 is an exemplary environment of computing devices for document clustering and text mining to which the various embodiments described herein may be implemented;

FIG. 2 illustrates computer-implemented method for clustering one or more documents, in accordance with an embodiment of the present invention;

FIG. 3A illustrates an information flow diagram for receiving one or more documents and extracting one or more features, in accordance with an embodiment of the present invention;

FIG. 3B illustrates an information flow diagram for iterating and clustering the one or more documents, in accordance with an embodiment of the present invention;

FIG. 4 illustrates a flow chart representing whole methodology, in accordance with another embodiment of the present invention;

FIG. 5 illustrates a use case diagram, in accordance with an embodiment of the present invention; and

FIG. 6 illustrates a component diagram, in accordance with the embodiment of the present invention.

### DETAILED DESCRIPTION OF THE DRAWINGS

The present invention is described hereinafter by various embodiments with reference to the accompanying drawing, wherein reference numerals used in the accompanying drawing correspond to the like elements throughout the description.

While the present invention is described herein by way of example using embodiments and illustrative drawings, those skilled in the art will recognize that the invention is not limited to the embodiments of drawing or drawings described and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes.

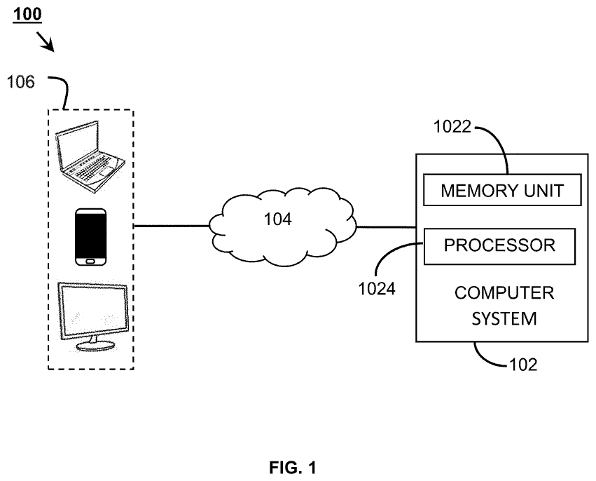

Referring to the drawings, the invention will now be described in more detail. FIG. 1 illustrates an exemplary environment of computing devices for document clustering and text mining to which the various embodiments described herein may be implemented. FIG. 1 shows a user interface module 106. The user interface module 106 is envisaged to include one or more display sources which may be LCD, LED or TFT screens with respective drivers. The user interface module 106 may have a driver board including a part of computational software and hardware needed to run devices provided with the user interface module 106.

The user interface module 106 may be a computing device selected from a group comprising a laptop, a desktop and a portable handheld device, having at least a display module, an input module and a user interface. The user interface module may be connected with a network 104. The network 104 may be one of, but not limited to, a Local Area Network (LAN) or a Wide Area Network (WAN). The network 104 may be implemented using a number of protocols, such as but not limited to, TCP/IP, 3GPP, 3GPP2, LTE, IEEE 802.x etc. further, the network 104 can be a short-range communication network and/or a long-range communication network, wire or wireless communication network. The communication interface includes, but not limited to, a serial communication interface, a parallel communication interface or a combination thereof. The communication is established over may be, but not limited to, wired network or wireless network such as GSM, GPRS, CDMA, Bluetooth, Wi-fi, Zigbee, Internet, intranet.

Further as shown in FIG. 1, a computer system 102 is connected to the network 104. The computer system 102 may be a portable computing device, a desktop computer or a server stack. The computer system 102 is envisaged to include computing capabilities such as a memory unit 1022 configured to store machine readable instructions. The machine-readable instructions may be loaded into the memory unit 1022 from a non-transitory machine-readable medium such as, but not limited to, CD-ROMs, DVD-ROMs and Flash Drives. Alternately, the machine-readable instructions may be loaded in a form of a computer software program into the memory unit 1022. The memory unit 1022 in that manner may be selected from a group comprising EPROM, EEPROM and Flash memory. Further, the computer system 102 includes a processor 1024 operably connected with the memory unit 1022. In various embodiments, the processor 1024 is one of, but not limited to, a general-purpose processor 1024, an application specific integrated circuit (ASIC) and a field-programmable gate array (FPGA).

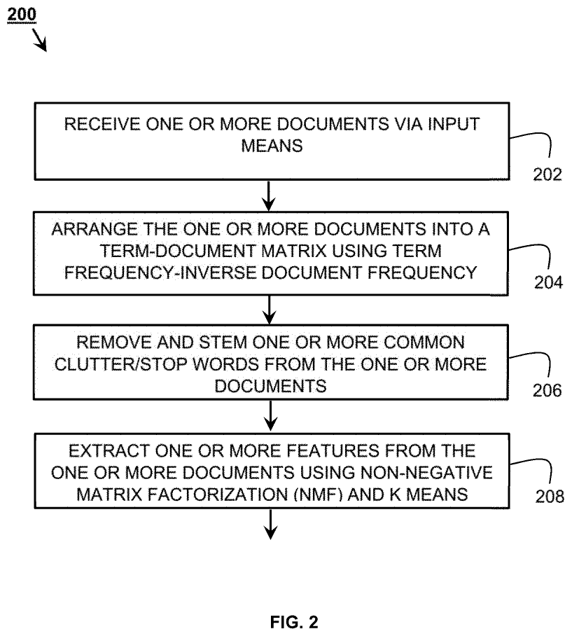

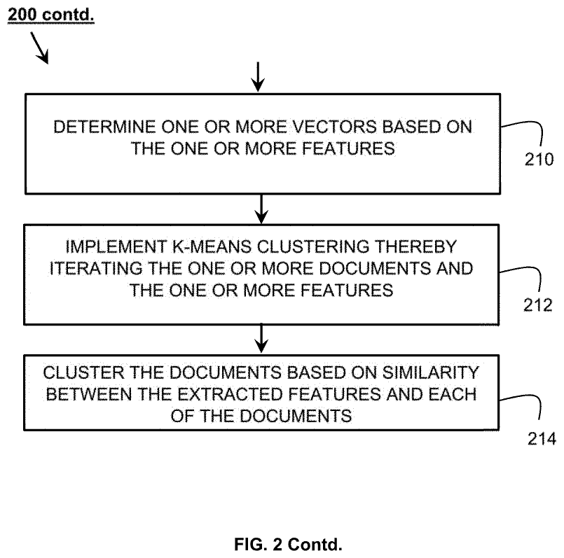

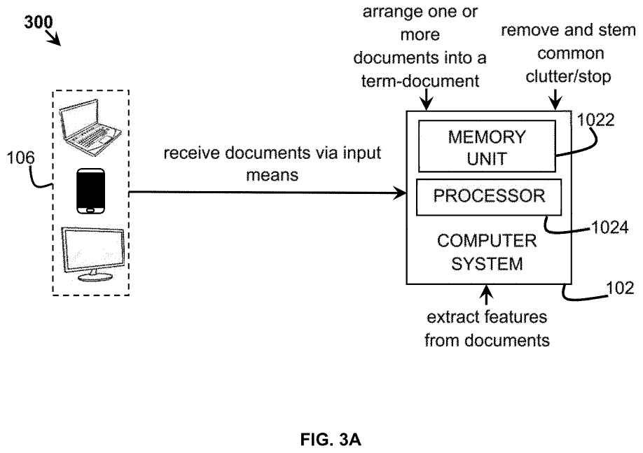

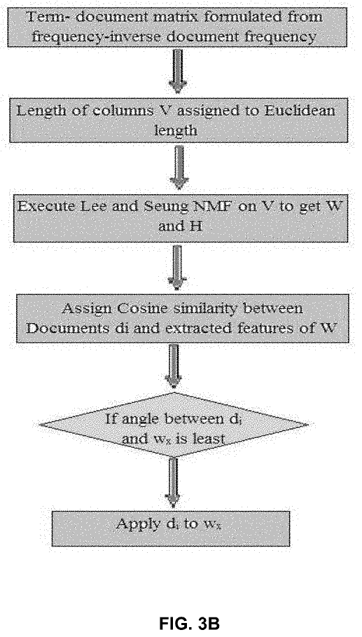

FIG. 2 illustrates computer-implemented method for document clustering. As shown in FIG. 2, the method 200 begins at step 202. At this step, the processor of the computer system receives one or more documents via one or more user interface module as shown in FIG. 3A. The one or more documents may be received by the processor from the user interface module through the network.

Next at step 204, the processor is configured to arrange the one or more documents into a term-document matrix using term frequency-inverse document frequency, as shown in FIG. 3A. In the preferred embodiment, the matrix is matrix V. At this step, length of columns of the matrix V is assigned to unit Euclidean length. Further, the method involves execution of non-negative matrix factorization (NMF) based on Lee and Seung on V and get matrix W and matrix H. For example, the documents access the term-document matrix be V={d1, d2, d3 . . . dn}

Later, at step 206, the processor is configured to remove and stem one or more common clutter/stop words from the one or more documents, as shown in FIG. 3A. The one or more Common clutter/stop words are removed using may be, but not limited to, keywords from Key Phrase Extraction Algorithm. Further, stem the one or more common clutter/stop words using may be, but not limited to, Porter algorithm.

Then, at step 208, the processor is configured to extract one or more features from the one or more documents performing NMF and k means clustering model. The same has been shown in FIG. 3A. The k-means clustering model may be configured to perform a method of vector quantization, originally from signal processing, that is popular for cluster analysis in data mining.

Following, at step 210, the processor is configured to determine one or more vectors based on the one or more features, as shown in FIG. 3B. For example, extracted include vectors be F={f1, f2, f3 . . . fk} computed by NMF.

Next, at step 212, the processor is configured to, implement k-means clustering. The k means clustering model may be configured to perform k means clustering algorithm to iterate the one or more documents and the one or more features.

For example, In the k means and the NMF, the document clustering is done on premise of the likeness between the extracted features and the individual documents. Let extracted include vectors be F={f1, f2, f3 . . . fk} computed by NMF. Give the documents access the term-document matrix be V={d1, d2, d3 . . . dn}. On application of cosine similarity to measure distance between the documents d and extracted features/vectors of W. Considering assignment of di to wx if the angle between di and wi is smallest, then document di is said to have a place with cluster fx if the edge amongst di and wi is least.

Subsequently at step 214, the processor is configured to cluster the one or more documents based on similarity between the extracted one or more features and the each of the one or more documents. Further, as shown in the FIG. 3B, the cluster of the one or more documents may be accessible at the user interface module.

In one embodiment, in case the one or more documents are large in size, implementing MapReduce to perform text mining. Further, the implementation of the MapReduce may reduce computational time. The MapReduce is a programming model and an associated implementation for processing and generating big data sets with a parallel, distributed algorithm on a cluster. The MapReduce framework of apache Hadoop project may be used for parallel implementation of k-means algorithm.

In one embodiment, further the processor is configured to form an index of the one or more documents using an index server such as may be, but not limited to, apache Lucene. Apache Lucene is a free and open-source search engine software library. Moreover, in case the one or more documents are new, the processor is configured to define and update the one or more documents in the index.

Illustrative Example:

In accordance with an embodiment of the present invention, working model based on update rules for NMF is presented for automatic document clustering with an application developed for its implementation. For the experimentation purpose of this model, the data set from Newgroup 20 may be be used. To aid to NMF, removal of common clutter/stop words using keywords from Key Phrase Extraction Algorithm and stemming from Porter algorithm may be utilized in preprocessing step. Finally, to study the performance of the MapReduce framework in Hadoop the parallel implementation of k-means clustering algorithm is to be used.

An application may be developing using apache Lucene for indexing documents and MapReduce framework of apache Hadoop project is used for parallel implementation of k-means algorithm from apache mahout project. This application is named as ‘Text Mining Lead’. The performance of models with proposed technique is conducted on news from 20 newsgroups datasets. Thus, by using the feature extracted using NMF may be used to cluster documents considering them to be final cluster labels as in k-means, and for large scale documents the parallel implementation using MapReduce may lead to reduction of computational time.

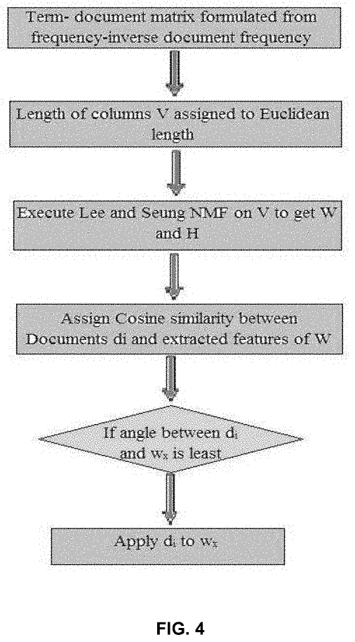

FIG. 4 illustrates a flow chart representing whole methodology, in accordance with another embodiment of the present invention. According to physical structure as shown in FIG. 4,
1. Formulate the term-document matrix V from the files of a given folder using term frequency-inverse document frequency.
2. Assign length of columns of V to unit Euclidean length.
3. Execute NMF based on Lee and Seung [3] on V and get W and H using (3)
4. Assign cosine similarity to measure distance between the documents di and extracted features/vectors of W. Apply di to wx if the angle between di and wx is least. This is equivalent to k-means algorithm with a single turn. To run the parallel form of k-means algorithm, Hadoop is begun in local reference mode and pseudo-distributed mode and the k-means job is submitted to the JobClient. The time taken for ventures from 1 through 3 and the aggregate time taken may be noted independently.

Steps in indexing the documents in a folder:
1. Define if the document is new, update in index if it is not updated in index.
2. Nothing is needed to be done if it's up to date what follows. Create a Lucene document if the document is new, and also check if it's not updated then delete the old document and create new Lucene Document.
3. Next words are to be extracted from the document.
4. Stop words are removed.
5. Stemming is to be applied.
6. Created Lucene Document is stored in index.
7. Stray files are removed.

The Lucene Document contains three fields: path, contents and altered which respectively stores the full-path of the record, the terms and altered date (to seconds). The field path is utilized to exceptionally distinguish documents in the index list, the field altered is used to dodge re-indexing the documents again if it's not changed. In the step 7 the documents which have been removed from the folder however with entries in the record are removed from index list. This step has been taken after to keep the optimal word dictionary size. The default stop-words were appended from the Key Phrase Extraction Algorithm [6] project which includes some 499 stop-words. The stop-words can be read from text file and users can adjoin words to the text file. The document was stemmed by the Porter algorithm after the removal of the stop-words.

The design and implementation of the application of proposed system “Text Mining Lead”. The software information's are as following:

| | |
|---|---|
| Software Version | 1.0 |
| Programming Language | Java |
| Referred | |
| Platform used | Only tested in GNU/Linux |
| Preferred IDE | NetBeans IDE 6.0.1 |
| UML Software | Umbrello UML Modeller 2.0.3 |
| Documentation | |
| License | Notified after successful implementation |
| Website | Notified after successful implementation |

Since Hadoop, Lucene and Mahout are worked with Java locally, it would be simple for interoperability between the parts created with Java. Considering this reality, Java was picked as the programming language. Umbrello UML Modeler has a basic yet effective arrangement of demonstrating instruments, because of which it was utilized for UML Documentation. NetBeans IDE was picked as formative IDE accounting to its rich arrangement of elements and simple GUI Builder tool.

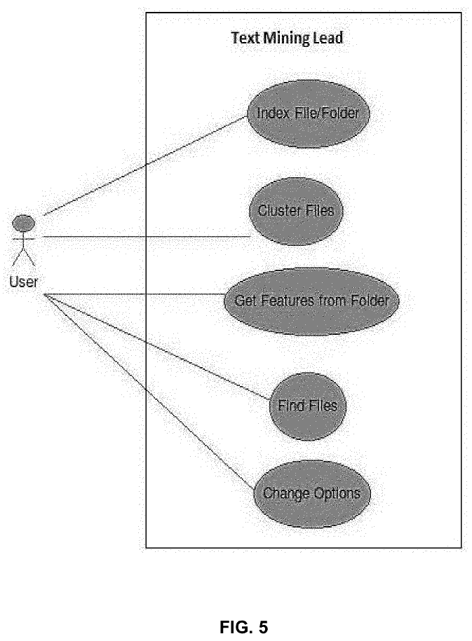

Further, FIG. 5 illustrates a use case diagram, in accordance with an embodiment of the present invention. As shown in FIG. 5, Clients of “text Mining Lead” connect with the framework as per the indicated cases. Clients may pick how to perform clustering. It should be possible with/without utilizing NMF and additionally with/without utilizing Hadoop. Additionally, these two noteworthy use cases, clients may get the primary elements from the organizer, for this again NMF may be utilized and components are indicated by the words with most extreme weights in matrix W. Clients likewise can discover the documents they are searching for on the off chance that they know the date of alteration. Records are show as indicated by the extracted feature requested by the weights in grid H. Moreover, the Clients have the choice to change parameters like number of words to speak to every component or feature, number of documents to be appeared under the elements, NMF parameters like joining/cycles, petition for stop words, location of file, area of organizers to be filed and so forth.

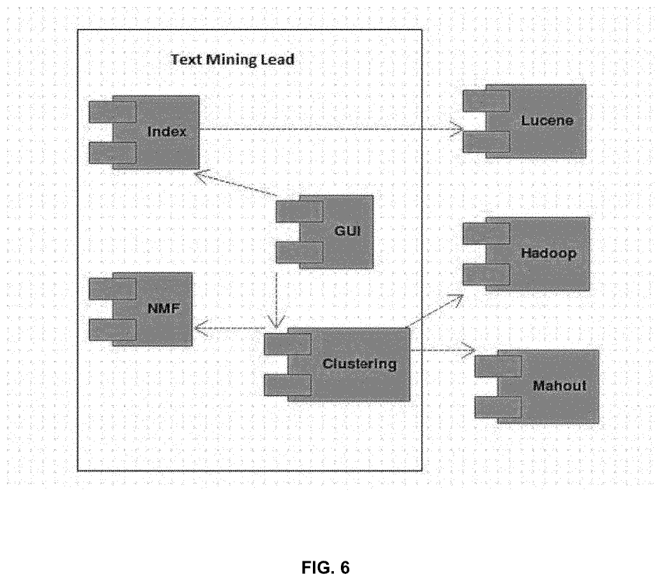

FIG. 6 illustrates a component diagram, in accordance with an embodiment of the present invention. The sample Component Diagram of Proposed Application “Text Mining Lead”, as shown in FIG. 6. The real segments of “Text Mining Lead” are appeared in the FIG. 6. The core components are appeared inside the box and the dependent component are appeared outside. The record part has classes utilized for reading/writing in touch with file, the Lucene Document and classes to make archive term framework from the file. The NMF part has classes for the NMF calculation by Lee and Seung [3] and utility class to perform operation like removing the top words in components, best documents in elements and so forth. Clustering segment has classes to run clustering lastly the GUI part has the class for UI and the main class of the application. Outer components are Lucene that has been utilized for ordering, the Mahout APIs for running MapReduce operation and Hadoop to begin the Hadoop Distributed File System.

In accordance with an embodiment of the present invention, Proposed Iterated Lovin Stemmer Algorithm along with existing lovins and porter stemmer algorithms as a result elimination of suffixes and Iterated stemming of the given word. Word is converted to lower case. The final clusters are the features extracted from the NMF algorithms, the parallelization strategy of map-reduce can be applied to compute the distance between the data vectors and the feature vectors. Since it requires only one iteration, it can be considered as having only one map-reduce operation. Furthermore, since the cluster centered computation isn't needed, only one map operation is sufficient. The map operation intakes the list of feature vectors and individual data vectors and outputs the closest feature vector for the data vector. For instance, we have list of data vectors V={v1,v2, . . . vn} and list of feature vectors W={w1,w2,w3} computed by NMF. Then, <vi , W>→map→<vi, wx> where wx is the cosine similarity feature vector to data vector vi.

The invention has various advantages. Normally the name of document is sufficient to give impression of the contents of the files as needs be to which the files can be grouped together. This invention is helpful when the number of documents is in huge number, the invention can successfully recognize and cluster the documents. The invention can be used to organize documents into subfolders without having to know about the contents of the document, which improves the performance of information retrieval in any scenario. Furthermore, the invention can be used to cluster documents as well as text mining.

It should be noted that where the terms “server”, “secure server” or similar terms are used herein, a communication device is described that may be used in a communication system, unless the context otherwise requires, and should not be construed to limit the present disclosure to any particular communication device type. Thus, a communication device may include, without limitation, a bridge, router, bridge-router (router), switch, node, or other communication device, which may or may not be secure.

Further, the operations need not be performed in the disclosed order, although in some examples, an order may be preferred. Also, not all functions need to be performed to achieve the desired advantages of the disclosed system and method, and therefore not all functions are required.

In general, the word “module,” as used herein, refers to logic embodied in hardware or firmware, or to a collection of software instructions, written in a programming language, such as, for example, Java, C, Python or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

Further, while one or more operations have been described as being performed by or otherwise related to certain modules, devices or entities, the operations may be performed by or otherwise related to any module, device or entity. As such, any function or operation that has been described as being performed by a module could alternatively be performed by a different server, by the cloud computing platform, or a combination thereof. It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publicly accessible network such as the Internet.

It should also be understood that, unless specifically stated otherwise as apparent from the following discussion, it is appreciated that throughout the description, discussions utilizing terms such as “controlling” or “obtaining” or “computing” or “storing” or “receiving” or “determining” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

The terms and descriptions used herein are set forth by way of illustration only and are not meant as limitations. Examples and limitations disclosed herein are intended to be not limiting in any manner, and modifications may be made without departing from the spirit of the present disclosure. Those skilled in the art will recognize that many variations are possible within the spirit and scope of the disclosure, and their equivalents, in which all terms are to be understood in their broadest possible sense unless otherwise indicated.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and appended claims.

We claim:

1. A computer implemented method for document clustering and text mining, the computer-implemented method comprising:
receiving one or more documents via one or more user interface module;
arranging the one or more documents into a term-document matrix using term frequency-inverse document frequency;
removing and stemming of one or more common clutter/stop words from the one or more documents;
extracting one or more features from the one or more documents performing non-negative matrix factorization (NMF) and k means clustering model;
determining one or more vectors based on the one or more features;
implementing k-means clustering model thereby iterating the one or more documents and the one or more features; and
clustering the one or more documents based on similarity between the extracted one or more features and each of the one or more documents.

2. The computer-implemented method as claimed in claim 1, further including forming an index of the one or more documents using an index server.

3. The computer-implemented method as claimed in claim 1, wherein the one or more documents are large in size, implementing MapReduce to cluster the one or more documents thereby performing text mining and reducing computational time.

4. The computer-implemented method as claimed in claim 2, wherein the one or more documents are new, defining and updating the one or more documents in the index.

5. A computer system for document clustering and text mining, the computer system comprising:
a memory unit configured to store machine-readable instructions; and
a processor operably connected with the memory unit, the processor the machine-readable instructions from the memory unit, and being configured by the machine-readable instructions to:
receive one or more documents via one or more user interface module;
arrange one or more documents into a term-document matrix using term frequency-inverse document frequency;
remove and stem one or more common clutter/stop words from the one or more documents;
extract one or more features from the one or more documents performing non-negative matrix factorization (NMF) and k means clustering model;
determine one or more vectors based on the one or more features;
implement k-means clustering model thereby iterating the one or more documents and the one or more features; and
cluster the one or more documents based on similarity between the extracted one or more features and the each of the one or more documents.

6. The computer system as claimed in claim 5, further including an index server configured to form an index of the one or more documents.

7. The computer system as claimed in claim 5, wherein the one or more documents are large in size, implementing MapReduce to cluster the one or more documents thereby performing text mining and reducing computational time.

8. The computer system as claimed in claim 6, wherein the one or more documents are new, define and update the one or more documents in the index.
